(19) United States
(12) Patent Application Publication
(10) Pub. No.: US 2025/0196967 A1
(43) Pub. Date: Jun. 19, 2025

(54) SUSPENSION SYSTEM FOR BICYCLE

(71) Applicant: Specialized Bicycle Components, Inc., Morgan Hill, CA (US)

(72) Inventors: Anthony Richard Trujillo, Aptos, CA (US); Michael Lawrence McAndrews, Aptos, CA (US); Brian Daniel Robinson, Newcastle, CA (US)

(21) Appl. No.: 18/981,174

(22) Filed: Dec. 13, 2024

Related U.S. Application Data
(60) Provisional application No. 63/612,165, filed on Dec. 19, 2023.

(51) Int. Cl. B62K 25/08; B62J 45/413; B62J 45/42; G01D 5/14

(52) U.S. Cl. CPC B62K 25/08; B62J 45/413; B62J 45/42; G01D 5/14

(57) ABSTRACT

A suspension system for a bicycle includes a first body defining a hollow interior, a second body configured to slide linearly within the hollow interior along an axis, and a rod disposed partially within the hollow interior and engaged with the second body. The rod extends along the axis. The suspension system also includes a sensor disposed outside of the hollow interior. Linear movement of the second body within the hollow interior along the axis is configured to create rotational movement of the rod about the axis, and the sensor is configured to detect the rotational movement to determine a linear displacement of the second body.

### CROSS-REFERENCE TO RELATED APPLICATIONS

This application claims priority to U.S. Provisional Application No. 63/612,165, filed Dec. 19, 2023, the entire contents of which are incorporated herein by reference.

### FIELD

The present disclosure relates to a suspension system, including a suspension system for a bicycle.

### BACKGROUND

A bicycle may include one or more suspension systems that absorb vibrational energy as the bicycle is rode over uneven terrain. The suspension system(s) may be located on and/or within a frame of the bicycle. In some examples, the suspension system(s) may include a front suspension system, such as, for example, a telescopic fork suspension system. Understanding the behavior of the suspension system(s) can be advantageous to permit the suspension system(s) to be tuned (e.g., to a rider of the bicycle or to the terrain being ridden), thereby improving the performance of the bicycle and/or the suspension system(s).

### BRIEF DESCRIPTION OF THE DRAWINGS

FIG. 1 is a side view of a bicycle according to one example, schematically illustrating an example of a front fork.

FIG. 2 is a partial, front view of the front fork, schematically illustrating a suspension system within the front fork.

FIG. 3 is a perspective view of the suspension system.

FIG. 4 is a partial, perspective view of the suspension system, with a first body of the suspension system shown in transparency.

FIG. 5 is a partial, perspective view of the suspension system, with the first body removed.

FIG. 6 is a perspective view of a rod of the suspension system.

FIG. 7 is a partial, cross-sectional view of the suspension system in a first state.

FIG. 8 is a partial, cross-sectional view of the suspension system in a second state.

FIG. 9 is a partial, cross-sectional perspective view of the suspension system, illustrating a top cap of the suspension system, and a magnet.

FIG. 10 is a partial, perspective view of the suspension system, illustrating a sensor coupled to the top cap.

FIG. 11 is a partial, cross-sectional view of a suspension system with a magnet and magnet location according to another example.

FIG. 12 is a partial, perspective view of the suspension system of FIG. 11, illustrating a sensor for the magnet.

### DETAILED DESCRIPTION

Before any constructions of the disclosure are explained in detail, it is to be understood that the disclosure is not limited in its application to the details of construction and the arrangement of components set forth in the following description or illustrated in the accompanying drawings. The disclosure can support other constructions and of being practiced or of being carried out in various ways.

According to one example, a suspension system for a bicycle includes a first body defining a hollow interior, a second body configured to slide linearly within the hollow interior along an axis, and a rod disposed partially within the hollow interior and engaged with the second body. The rod extends along the axis. The suspension system also includes a sensor disposed outside of the hollow interior. Linear movement of the second body within the hollow interior along the axis is configured to cause rotational displacement of the rod about the axis, and the sensor is configured to detect the rotational displacement to determine a linear displacement of the second body.

According to another example, a suspension system for a bicycle includes a first, elongate tubular body defining a hollow interior, a second, elongate tubular body configured to slide linearly within the first, elongate tubular body, a rod disposed partially within the hollow interior, and a top cap coupled to the first, elongate tubular body. The rod extends into the top cap. The suspension system also includes a magnet coupled to the rod. The magnet is positioned within the top cap and outside of the hollow interior. The suspension system also includes a sensor coupled to the top cap. The sensor is configured to detect rotational displacement of the magnet.

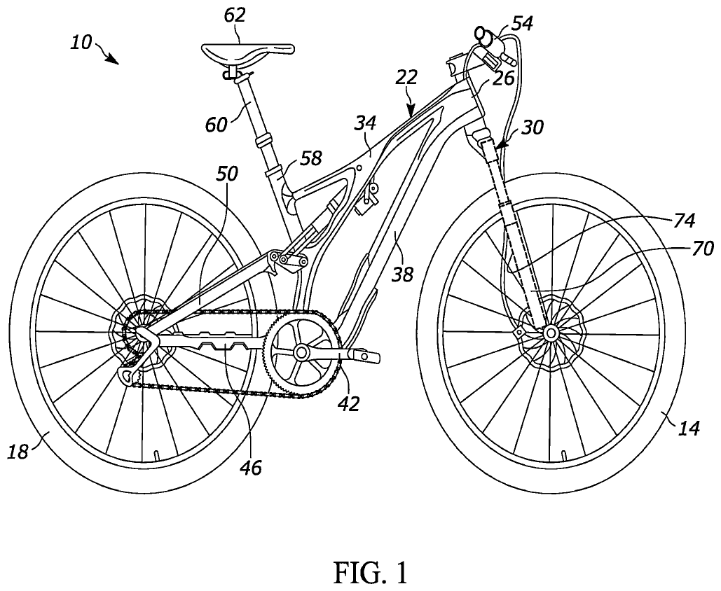

FIG. 1 shows a bicycle 10 that includes a front wheel 14, a rear wheel 18, and a frame 22 supported by the front wheel 14 and the rear wheel 18. Although the bicycle 10 is illustrated in FIG. 1 as an analog bicycle, in other examples, the bicycle 10 can be an electric bicycle. Further, although a particular configuration of the frame 22 is illustrated in FIG. 1, the bicycle 10 may be implemented with other configurations of the frame 22 than that which is illustrated. In these examples, frame 22 may be implemented with other configurations having different shapes, sizes, and/or frame components.

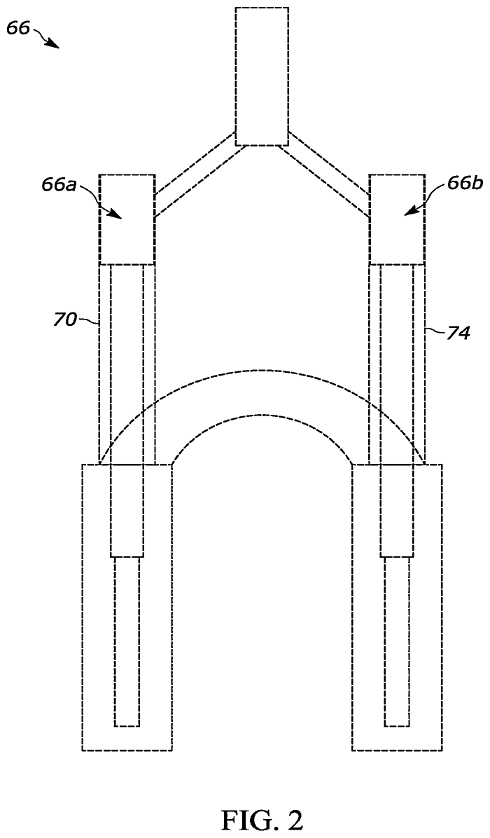

In some examples, the frame 22 may include a head tube 26, a front fork 30 (illustrated schematically in FIGS. 1 and 2) rotationally supported by the head tube 26, a top tube 34 connected to and extending rearward from the head tube 26, and/or a down tube 38 connected to the head tube 26 below the top tube 34 and extending rearward from the head tube 26. In many examples, the front fork 30 can include a first leg 70 (FIG. 2) and/or a second leg 74 (FIG. 2). In further examples, the front fork 30 (e.g., the first leg 70 and/or the second leg 74 of the front fork 30) can be coupled to the front wheel 14 (e.g., to an axle and/or hub of the front wheel 14)

In some examples, the frame 22 may include a bottom bracket, and the down tube 38 may extend generally downward from the head tube 26 and toward the bottom bracket of the frame 22. The bottom bracket of the frame 22 may receive a crankset 42 of a drivetrain of the bicycle 10.

In some examples, the frame 22 may include a seat tube 58. The seat tube 58 may be connected to the top tube 34 and/or the bottom bracket of the frame 22. The seat tube 58 may support a seat post 60, and/or a seat 62. For example, the seat tube 58 may receive the seat post 60, which may support the seat 62. The seat post 60 and/or seat 62 may be adjustable (e.g., vertically) relative to the seat tube 58, such as, for example, to accommodate for different sizes of riders and/or for different slopes of terrain.

In some examples, the frame 22 may include a chainstay 46 and/or a seatstay 50. Further, the frame 22 may also, in some examples, include a frame triangle (e.g., rear triangle) that supports the rear wheel 18, and the frame triangle may include the chainstay 46 and/or the seatstay 50.

In some examples, the bicycle 10 may also include a handlebar 54 for turning the front wheel 14 via the front fork 30. In these or other examples, the bicycle 10 may include the seat post 60 and/or the seat 62.

With reference to FIGS. 2-10, the bicycle 10 includes at least one suspension system 66. For example, the suspension system(s) 66 may be located at one or more positions on the bicycle 10, including on or within the frame 22 (e.g., on or within the front fork 30). In further examples, one or more of the suspension system(s) 66 may be part of the frame 22 (e.g., the front fork 30). The suspension system(s) 66 may absorb vibrational energy (e.g., impacts) as the bicycle 10 is rode over uneven terrain, and may include springs (e.g., coil springs, fluid or air springs, elastomer springs), dampers, resilient materials, and/or other elements that individually, or in combination, facilitate absorption of vibrational energy (e.g., impacts).

In some examples, one or more of the suspension system(s) 66 may be coupled (e.g., directly coupled) between two frame components of the frame 22. In other examples, one or more of the suspension system(s) 66 may be coupled (e.g., directly coupled) between a frame component of the frame 22 and one or more of the front wheel 14 and the rear wheel 18. In yet other examples, one or more of the suspension system(s) 66 may be coupled (e.g., directly coupled) between a frame component of the frame 22 and the handlebar 54, the seat post 60, and/or the seat 62. In these or other examples, other quantities and/or positions of suspension systems 66 may be implemented. In many embodiments, one or more of the suspension system(s) 66 can be a front suspension system (e.g., a telescopic fork suspension system) of the bicycle 10.

In some examples, and as illustrated in FIG. 2, the bicycle 10 includes one suspension system 66. For example, the suspension system 66 may be a front suspension system (e.g., a telescopic fork suspension system) of the bicycle 10. In some examples, the front fork 30 can include the suspension system 66. The suspension system 66 is configured to absorb vibrational energy (e.g., impacts) received by the bicycle 10 (e.g., through the front wheel 14).

In some examples, and as further illustrated in FIG. 2, the suspension system 66 can include a suspension element 66a and a suspension element 66b. The suspension element 66a can include a spring (e.g., an air spring), and the suspension element 66b can include a damper (e.g., a hydraulic damper). In many examples, the suspension element 66b can include one or more components of a conventional damper or hydraulic damper of a telescopic fork suspension system.

In many examples, including the example illustrated in FIG. 2, the suspension element 66a is positioned in the first leg 70 of the front fork 30, and the suspension element 66b is positioned in the second leg 74 of the front fork 30. In these examples, the suspension element 66a can be a spring cartridge received at the first leg 70 of the front fork 30, and the suspension element 66b can be a damper cartridge received at the second leg 74 of the front fork 30. In other examples, the suspension element 66a can be part of the first leg 70, and/or suspension element 66b can be part of the second leg 74. In these examples, the suspension element 66a and/or the suspension element 66b can be part of the chassis of the front fork 30.

In some examples, the bicycle 10 can include additional suspension systems 66. In further examples, other quantities and/or positions of suspension systems 66 may be implemented. In these or other examples, the bicycle 10 can include one or more suspension system(s) other than the suspension system(s) 66.

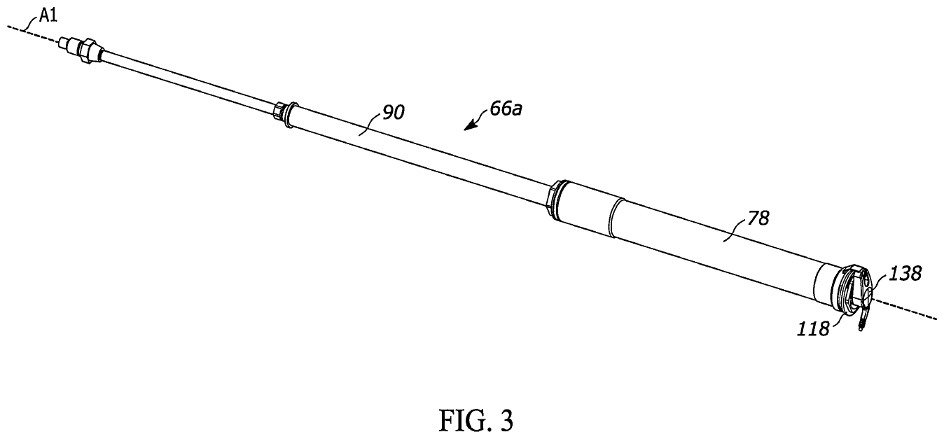

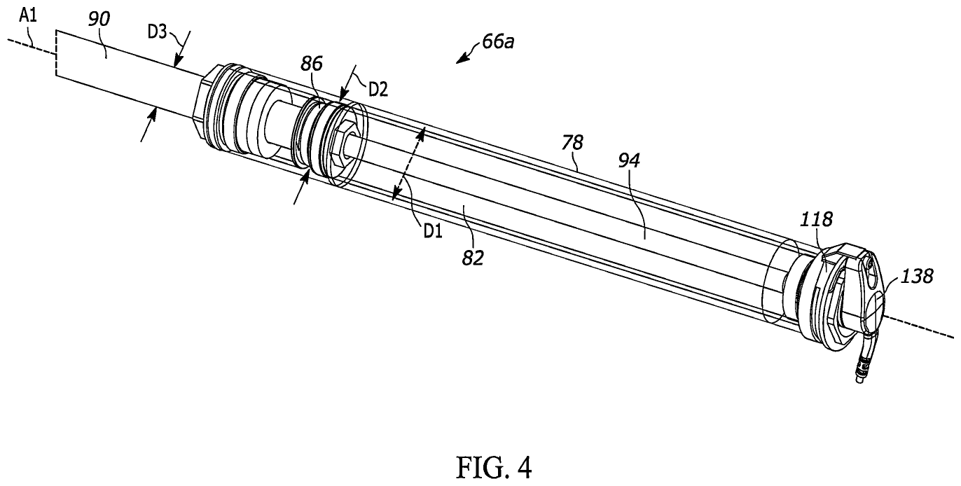

With reference to FIGS. 3 and 4, in some examples, the suspension element 66a may include a first body 78. The first body 78 may define a hollow interior 82 (FIG. 4).

In the illustrated example, the first body 78 is an elongate, tubular body that extends along an axis A1 (e.g., a longitudinal axis). In some examples, the hollow interior 82 is a sealed, or partially sealed, hollow interior 82. The first body 78 may have an axial length (along the axis A1) greater than an overall outer diameter of the first body 78, and may have a circular cross-sectional shape. Other examples may include other shapes and/or sizes than that illustrated (e.g., a first body 78 defining a shorter tubular body than that illustrated, with a diameter greater than an axial length, and/or having a non-circular cross-sectional shape such as a square, oval, etc.).

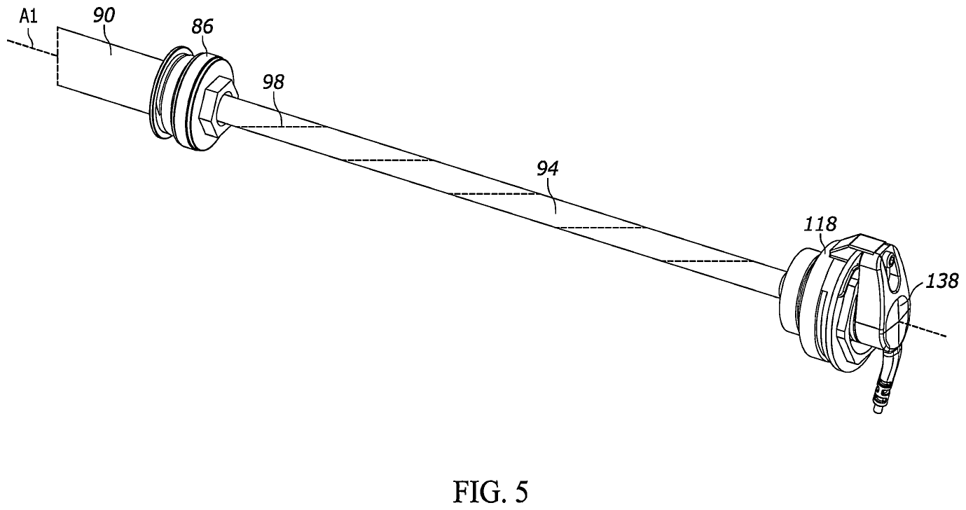

With reference to FIGS. 4 and 5, in some examples, the suspension element 66a may also include a second body 86. The second body 86 may slide linearly along the axis A1 within the hollow interior 82 of the first body 78. The second body 86 can be configured to compress a spring (e.g., a fluid or air spring, a coil spring, an elastomeric spring) positioned within the hollow interior 82 of the first body 78, which may function as the spring of suspension element 66a.

In the illustrated example, the second body 86 is a piston that slides within the hollow interior 82, and the spring is an air spring. The second body 86 may be positioned, for example, at the distal end of a separate elongate structure (e.g., tube, rod, etc.), or may otherwise be coupled to a portion of the bicycle 10 (e.g., to the front wheel 14, such that when the front wheel 14 experiences uneven terrain, the front wheel 14 will cause the second body 86 to slide upwardly through the hollow interior 82), thereby compressing the spring of suspension element 66a. In other embodiments, the second body 86 can have features other than that illustrated.

As illustrated in FIGS. 4 and 5, in some examples, the second body 86 may be coupled to the distal end of a third body 90 (e.g., an elongate tube and/or main shaft). The second body 86 may be fixed to the third body 90, and in some examples the third body 90 may be fixed for example to an extended shaft and/or lower post, the lower post being fixed for example to a bottom of a fork chassis lower leg. Other examples include different arrangements of components and connections. Overall, the second body 86 may be arranged such that it translates linearly, but for example does not rotate, with the hollow interior 82.

With continued reference to FIGS. 4 and 5, the first body 78 may have an inner diameter D1, the second body 86 may have an outer diameter D2, and the third body 90 may have an outer diameter D3. The outer diameter D3 may be less than the inner diameter D1. The outer diameter D2 may be greater than the outer diameter D3. The outer diameter D2 may be less than or substantially equal to the inner diameter D1. In other examples, the second body 86 may instead have other shapes and/or sizes than that illustrated, including non-circular shapes (e.g., square, oval, etc.). Other examples may also include different diameters than that illustrated.

In some examples, the second body 86 may have, for example, an outer gasket, or flexible membrane, that flexes and/or slides along an interior surface of the first body 78. For example, the outer gasket or flexible membrane can seal or partially seal a first volume of the hollow interior 82 from a second volume of the hollow interior 82 separate from the first volume by the second body 86. Air or other fluid within the first volume of the hollow interior 82 may function as the air spring of the suspension element 66a.

In some examples, the second body 86 may include one or more regions that permit movement of fluid (e.g., air) axially around and/or through the second body 86. These region(s) may be implemented to modify a spring curve of the spring of the suspension element 66a.

In some examples, the first body 78 and/or the second body 86 may include grease or other lubricating substances. The grease or other lubricating substances can facilitate sliding movement of the second body 86 within the first body 78.

With reference to FIGS. 4-8, in some examples, the suspension element 66a may include a rod 94 disposed at least partially within the hollow interior 82 of the first body 78. The rod 94 may extend along the axis A1, and may be engaged with the second body 86, such that linear movement of the second body 86 along the axis A1 generates rotational movement of the rod 94 about the axis A1. In other examples, the rod 94 may be positioned outside of the hollow interior 82.

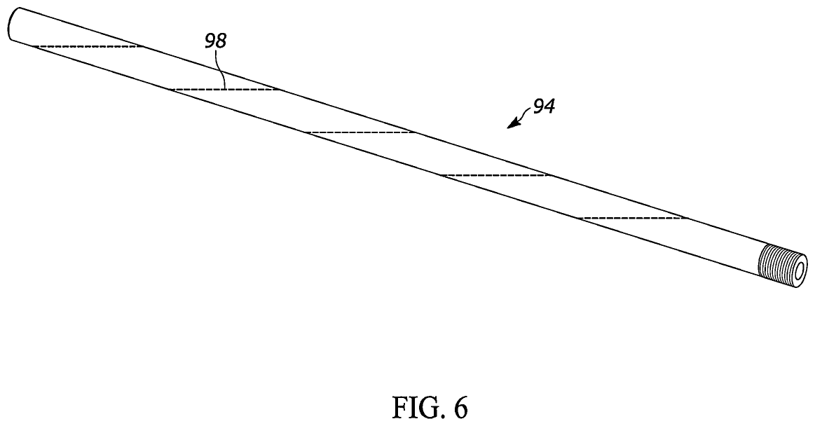

With reference to FIGS. 5 and 6, in some examples, the rod 94 may include a first keyed feature (e.g., thread, protrusion, groove, and/or other structure) located along an exterior (e.g., exterior surface) of the rod 94. In the illustrated example, the first keyed feature is an external thread 98 (illustrated schematically with broken lines). Other examples include other types of first keyed features (e.g., other external threads, protrusions, grooves, etc.), as well as other numbers or combinations of keyed features.

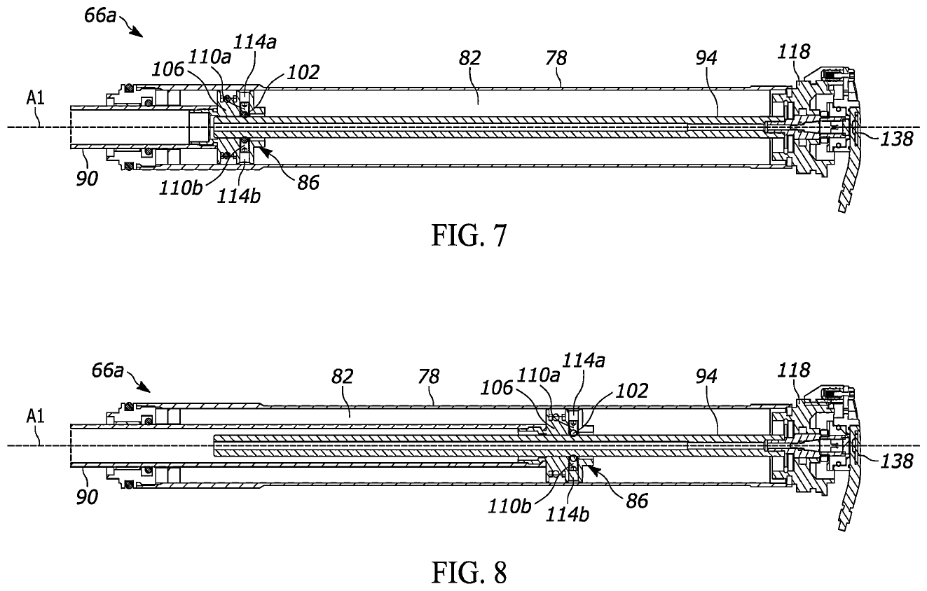

With reference to FIGS. 7 and 8, in some examples, the second body 86 may include a second keyed feature (e.g., thread, protrusion, groove, and/or other structure) located along or through the second body 86 and configured to receive or be received by the first keyed feature of the rod 94. In the illustrated example, the second keyed feature includes a protrusion 102 that engages the external thread 98. Other examples include other types of second keyed features (e.g., other external threads, protrusions, grooves, etc.), as well as other numbers or combinations of keyed features.

In some examples, and as illustrated in FIGS. 7 and 8, the second body 86 includes a main body 106, and a first set screw 110a that extends radially through a passage 114a in the main body 106. The set screw 110a includes a distal end that defines the protrusion 102 that engages the external thread 98. The second body 86 may further include one or more additional set screws and passages (e.g., a second set screw 110b and a second passage 114b), with each additional set screw (e.g., set screw 110b) defining additional protrusions that engage the external thread 98.

Other examples may include only a single set screw 110a, and further examples may omit any set screws at second body 86. For example, the protrusion 102 may be defined by a portion of the main body 106 itself (e.g., integrally formed as a single piece with the main body 106), in which example the set screws may be omitted. In some examples, the second body 86 includes a roller or rollers that engage the external thread 98. In some examples, the rod 94 includes an external protrusion, or roller, that engages an internal thread of the second body 86. Various other structures and arrangements of keyed features (e.g., protrusions, grooves, rollers, etc.) on the second body 86 and/or the rod 94 may be provided, so long as axial movement of the second body 86 along the axis A1 generates rotational movement of the rod 94 about the axis A1.

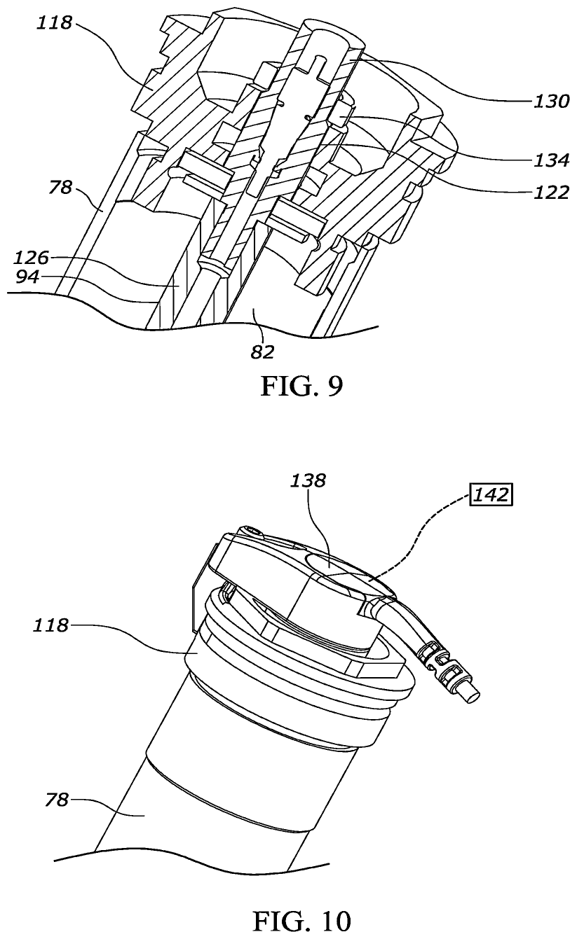

With reference to FIGS. 3-5 and 7-10, in some examples, the suspension element 66a may include a cap 118 (e.g., a top cap) coupled to the first body 78 (e.g., at a top end of the first body 78). The rod 94 may extend into the cap 118. For example, as seen in FIG. 9, the cap 118 may have a central opening 122, and the rod 94 may extend through the central opening 122. In some examples, the cap 118 is integrally formed as a single piece with the first body 78, or is separately coupled to the first body 78 (e.g., with threads). In other examples, the suspension system 66 does not include a cap 118. In some examples, the rod 94 does not extend into the cap.

With continued reference to FIG. 9, in the illustrated example, the rod 94 includes a main portion 126 (e.g., a hollow main portion), and a valve portion 130 coupled (e.g., rotationally fixed) to the main portion 126. The valve portion 130 may permit air or other fluid to enter the main portion 126 and/or the first body 78. The valve portion 130 rotates with the main portion 126. The main portion 126 may be positioned entirely within the hollow interior 82, and the valve portion 130 may extend through the central opening 122. Other examples do not include a valve portion 130, such as, for example, when a spring other than a fluid or air spring is implemented for the spring of suspension element 66a. For example, the main portion 126 may extend through the central opening 122 into the cap 118. Additionally, in some examples the main portion 126 may not be hollow. Instead, the main portion 126 may be entirely solid.

With continued reference to FIG. 9, in some examples, the suspension system 66 may include a magnet 134 coupled to the rod 94. In the illustrated example, the magnet 134 is positioned within the cap 118, and outside of the hollow interior 82. In other examples, the magnet 134 may not be positioned within the cap 118, and/or may not be positioned outside of the hollow interior 82. The magnet 134 may extend at least partially around the rod 94 (e.g., around the valve portion 130) and rotate with the rod 94. In other examples, the magnet 134 is not coupled to the valve portion 130 (e.g., is coupled to the main portion 126), and/or the suspension system 66 includes multiple magnets 134 that rotate with the rod 94. In some examples, the magnet 134 is centered on the rod 94, rather than for example encircling the rod 94. In some examples, the suspension system 66 does not include any magnets 134.

With reference to FIG. 10, the suspension system 66 includes a sensor 138 (e.g., a rotary sensor). The sensor 138 is configured to detect (e.g., measure) a rotational or angular displacement of a first component of the suspension system 66 (e.g., the rod 94) such that a linear displacement of a second component of the suspension system 66 (e.g., the second body 86) can be determined (e.g., calculated). For example, a linear displacement of the second body 86 can be determined (e.g., calculated) by converting a value of the rotational displacement of the first component that is detected to a value of linear displacement, which may represent or equate to a value of linear displacement of the second body 86. Meanwhile, the value of linear displacement of the second component (e.g., second body 86) may represent or equate to a value of linear displacement of the suspension system 66 and/or the suspension element 66a.

Implementing the sensor 138 to monitor the linear displacement or otherwise understand the behavior of the suspension system 66 and/or the suspension element 66a may be advantageous so that one or more of the suspension system(s) 66 and/or one or more other suspension systems of the bicycle 10 that are implemented can be tuned (e.g., for the user of the bicycle 10). In some examples, one or more suspension systems of bicycle 10 other than suspension system(s) 66 also may be tuned with the data collected by the sensor 138.

In many examples, the sensor 138 can be configured to communicate with one or more control systems 142 via wired or wireless communication, The control system(s) 142 can be configured to store values of rotational displacement detected by the sensor 138, to determine (e.g., calculate) values of linear displacement from the values of rotational displacement detected by the sensor 138, and/or to store values of linear displacement determined (e.g., calculated) by the control system(s) 142. In some examples, the control system(s) 142 may be located on the bicycle 10, a user of the bicycle 10, and/or at a location remote from the bicycle 10 and/or a user of the bicycle 10. For example, the control system(s) 142 may include a cycling computer on the bicycle 10, a smart phone of the user of the bicycle 10, and/or a remote server. In these or other examples, control system(s) 142 can include a computer system, which may be configured to store data and/or to perform mathematical calculations such as conversions of values of rotational or angular displacement to values of linear displacement. In other examples, the control system(s) 142 can be omitted.

In some examples, the sensor 138 can be disposed outside of the hollow interior 82. In other examples, the sensor 138 may be positioned inside the hollow interior 82. Positioning the sensor 138 outside of the hollow interior 82 may be advantageous to prevent the sensor from contacting grease or other lubricating substances located within the hollow interior 82, thereby preventing or mitigating degradation of the sensor 138. In some examples, the sensor 138 can be positioned over the cap 118. In many examples, is the sensor 138 can be positioned and configured to detect rotation of the magnet 134, which may represent or equate to a value of rotational displacement of the rod 94. The sensor 138 may be any type of sensor that detects rotational movement of the magnet 134 and/or the rod 94, or another feature or element on or connected to the rod 94. In some examples, the sensor 138 may be an optical sensor, a Hall sensor, a potentiometer, an encoder, or other sensors.

With reference to FIGS. 7-10, in some examples the rotational freedom, or range of rotation, of the rod 94 may be limited to less than 360 degrees. For example, the pitch of the external thread 98 may be selected such that any linear movement of the second body 86 creates a rotational movement of less than 360 degrees of the rod 94. In some examples, the pitch of the external thread 98 may be greater than 200 millimeters per revolution of the rod 94.

Accordingly, the sensor 138 may not need to recalibrate, or otherwise take into consideration, a rotational displacement of the rod 94 that has extended beyond 360 degrees (e.g., to determine a zeroing or resetting). Rather, any time the second body 86 moves within the first body 78 and then stops, or changes direction, the sensor 138 may be used to determine an axial displacement of the second body 86, based for example on the rotational position of the magnet 134. In other examples, however, the rod 94 may be permitted to rotate more than 360 degrees, and one or more other sensors may be implemented to determine the axial movement of the second body 86 based on the rotational movement of the rod 94.

During use, as the bicycle 10 rides over uneven terrain and hits a bump or uneven surface, the second body 86 may be pressed (e.g., upwardly) by the front wheel 14, and axially along the axis A1 within the hollow interior 82 of the first body 78. As the second body 86 moves along the axis A1, the second body 86 may pass over or along the rod 94, and the protrusion 102 may engage the external thread 98 of the rod 94, forcing the rod 94 to rotate about the axis A1. This rotation of the rod 94 may cause the magnet 134 to rotate. The sensor 138 may detect the rotation of the magnet 134. In some examples, the sensor 137 may then send a signal to one or more of the control system(s) 142, which may collect information regarding the movement of the second body 86 relative to the first body 78. Additionally, and as described above, other examples may include other features and combinations of features, including for example different types of sensors 138 and locations of sensors 138, different keyed features, different types or rods 94, and different arrangements of first and second bodies 78, 86 that move relative to each other to generate the rotational movement of the rod 94.

Some embodiments may include a frame, a front fork, a suspension system, a suspension element, and/or a control system. In these or other embodiments, the frame may be similar or identical to frame 22, the front fork may be similar or identical to the front fork 30 (FIG. 1), the suspension system may be similar or identical to suspension system 66 (FIG. 2), the suspension element may be similar or identical to the suspension element 66a (FIG. 2), and/or the control system may be similar or identical to the control system 142 (FIG. 10).

Further, although the sensor 138 and/or the control system(s) 142 are primarily described in connection with monitoring displacement, in many examples, the sensor 138 can additionally or alternatively monitor other characteristics (e.g., velocity, acceleration, zenith, stroke count, etc.) as may be desired, such as, for example, to tune, maintain, replace, etc. one or more of the suspension system(s) 66 or other suspension system(s) or other components of the bicycle 10.

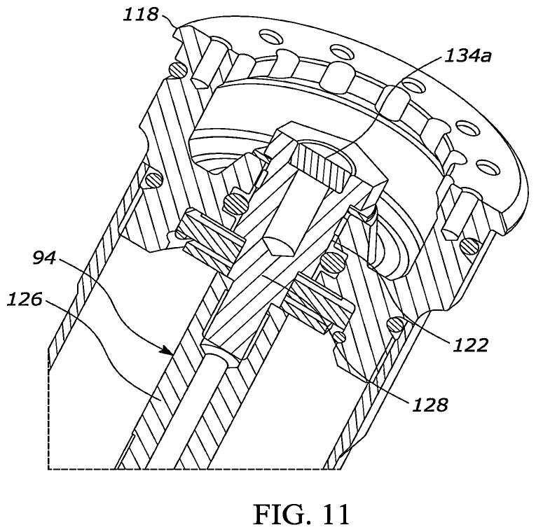

With reference to FIG. 11, in some examples the rod 94 may include a magnet 134a that is centered (e.g., radially centered), for example, at an axial end of the rod 94, or otherwise along the rod 94. The magnet 134a may be disc-shaped, or have other shapes and sizes than that illustrated. Similarly, and as described above, the magnet 134 may have other shapes than that illustrated (e.g., other than ring-shaped).

In some examples, and as described above, the rod 94 may not include a valve portion (such as the valve portion 130 described above). In yet other examples, the rod 94 may include a valve portion that is located at an opposite end of the suspension element from the magnet 134, 134a. In the example illustrated in FIG. 11, the rod 94 does not include a valve portion at the end of the rod 94 that includes the magnet 134a. Rather, the rod 94 includes an extension 128 that is coupled (e.g., rotationally fixed) to the main portion 126. The extension 128 extends through the opening 122 of the cap 118, and the magnet 134a is centered at (e.g., within) an end of the extension 128.

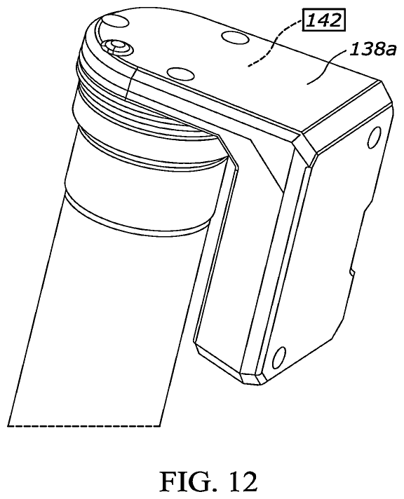

With reference to FIG. 12, a sensor 138a may be positioned over (e.g., directly over) the centered magnet 134a, and/or may be coupled to the control system(s) 142. In some examples, the sensor 138a may have a different shape and/or size than the sensor 138 described above. In the example illustrated in FIGS. 11 and 12, positioning the magnet 134a at the center of the rod 94 and the sensor 138a directly over the magnet 134a may help to reduce interference by other elements of the suspension element 66a.

The sensors 138, 138a described herein may be positioned directly over the magnets 134, 134a, normal to the magnets 134, 134a, and/or at other positions relative to the magnets 134, 134a. Overall, the position of the magnets 134, 134a and/or the sensors 138, 138a may affect the accuracy of the measurements sensed by the sensors 138, 138a. The position of the magnets 134, 134a and/or the sensors 138, 138a may be selected, therefore, to mitigate interference and/or to optimize communication of the sensors 138, 138a with the magnets 134, 134a.

Some of the examples described herein may be further described by reference to the following numbered clauses:
1. A suspension system for a bicycle, the suspension system comprising:
   a first body defining a hollow interior;
   a second body configured to slide linearly within the hollow interior along an axis;
   a rod disposed partially within the hollow interior and engaged with the second body,
      wherein the rod extends along the axis; and
   a sensor disposed outside of the hollow interior;
      wherein linear movement of the second body within the hollow interior along the axis is configured to cause rotational displacement of the rod about the axis, and wherein the sensor is configured to detect the rotational displacement to determine a linear displacement of the second body.
2. The suspension system of clause 1, wherein the rod includes a first keyed feature and the second body includes a second keyed feature engaged with the first keyed feature.
3. The suspension system of clause 2, wherein the first keyed feature is an external thread on the rod.
4. The suspension system of clause 3, wherein the second keyed feature is a protrusion of the second body that is engaged in the external thread.
5. The suspension system of clause 4, wherein the second body includes a set screw, and wherein an end of the set screw defines the protrusion.
6. The suspension system of any of the preceding clauses, wherein the first body is an elongate tube.
7. The suspension system of any of the preceding clauses, wherein the second body is a piston.
8. The suspension system of any of clauses 1-5 or 7, wherein the first body is a first elongate tube, wherein the suspension system further includes a second elongate tube, and wherein the piston is disposed at a distal end of the second elongate tube.
9. The suspension system of clause 8, wherein the first elongate tube has a first, inner diameter, wherein the second elongate tube has a second, outer diameter that is less than the first, inner diameter, and wherein the piston has a third, outer diameter that is greater than the second, outer diameter.
10. The suspension system of clause 1, wherein the rod includes an external thread, and wherein the second body is a piston engaged with the external thread, wherein a pitch of the external thread is such that any linear movement of the piston is configured to cause a rotational displacement of the rod that is less than 360 degrees.
11. The suspension system of any of the preceding clauses, further comprising a magnet coupled to the rod.
12. The suspension system of clause 11, further comprising a top cap coupled to an end of the first body, wherein the rod extends through the end of the first body and into the top cap, and wherein the magnet is disposed within the top cap and outside of the hollow interior.
13. The suspension system of clause 12, wherein the sensor is a rotary sensor coupled to the top cap and configured to detect rotational displacement of the magnet.
14. The suspension system of any of the preceding clauses, wherein a portion of the rod defines a valve.
15. A bicycle having a front fork, wherein the suspension system of any of the preceding clauses 1 is disposed at least partially within the front fork.
16. A suspension system for a bicycle, the suspension system comprising:
   a first, elongate tubular body defining a hollow interior;
   a second, elongate tubular body configured to slide linearly within the first, elongate tubular body;
   a rod disposed partially within the hollow interior;
   a cap coupled to the first, elongate tubular body, wherein the rod extends into the cap;
      a magnet coupled to the rod, wherein the magnet is positioned within the cap and outside of the hollow interior; and
      a sensor coupled to the cap, wherein the sensor is configured to detect rotational displacement of the magnet.
17. The suspension system of clause 16, wherein the rod includes an external thread, and wherein the second, elongate tubular body includes a piston engaged with the external thread.
18. The suspension system of clause 17, wherein a pitch of the external thread is such that any linear movement of the piston is configured to create a rotational displacement of the rod that is less than 360 degrees.
19. The suspension system of any of clauses 16-18, wherein the sensor is a rotary sensor configured to detect a rotational displacement of the magnet.
20. A bicycle having a front fork, wherein the suspension system of any of clauses 16-19 is disposed at least partially within the front fork.

Various features and advantages of the disclosure are set forth in the following claims.

1. A suspension system for a bicycle, the suspension system comprising:
a first body defining a hollow interior;
a second body configured to slide linearly within the hollow interior along an axis;
a rod disposed partially within the hollow interior and engaged with the second body, wherein the rod extends along the axis; and
a sensor disposed outside of the hollow interior;
wherein linear movement of the second body within the hollow interior along the axis is configured to cause rotational displacement of the rod about the axis, and wherein the sensor is configured to detect the rotational displacement to determine a linear displacement of the second body.

2. The suspension system of claim 1, wherein the rod includes a first keyed feature and the second body includes a second keyed feature engaged with the first keyed feature.

3. The suspension system of claim 2, wherein the first keyed feature is an external thread on the rod.

4. The suspension system of claim 3, wherein the second keyed feature is a protrusion of the second body that is engaged in the external thread.

5. The suspension system of claim 4, wherein the second body includes a set screw, and wherein an end of the set screw defines the protrusion.

6. The suspension system of claim 1, wherein the first body is an elongate tube.

7. The suspension system of claim 1, wherein the second body is a piston.

8. The suspension system of claim 7, wherein the first body is a first elongate tube, wherein the suspension system further includes a second elongate tube, and wherein the piston is disposed at a distal end of the second elongate tube.

9. The suspension system of claim 8, wherein the first elongate tube has a first, inner diameter, wherein the second elongate tube has a second, outer diameter that is less than the first, inner diameter, and wherein the piston has a third, outer diameter that is greater than the second, outer diameter.

10. The suspension system of claim 1, wherein the rod includes an external thread, and wherein the second body is a piston engaged with the external thread, wherein a pitch of the external thread is such that any linear movement of the piston is configured to cause a rotational displacement of the rod that is less than 360 degrees.

11. The suspension system of claim 1, further comprising a magnet coupled to the rod.

12. The suspension system of claim 11, further comprising a top cap coupled to an end of the first body, wherein the rod extends through the end of the first body and into the top cap, and wherein the magnet is disposed within the top cap and outside of the hollow interior.

13. The suspension system of claim 12, wherein the sensor is a rotary sensor coupled to the top cap and configured to detect rotational displacement of the magnet.

14. The suspension system of claim 1, wherein a portion of the rod defines a valve.

15. A bicycle having a front fork, wherein the suspension system of claim 1 is disposed at least partially within the front fork.

16. A suspension system for a bicycle, the suspension system comprising:
a first, elongate tubular body defining a hollow interior;
a second, elongate tubular body configured to slide linearly within the first, elongate tubular body;
a rod disposed partially within the hollow interior;
a cap coupled to the first, elongate tubular body, wherein the rod extends into the cap;
a magnet coupled to the rod, wherein the magnet is positioned within the cap and outside of the hollow interior; and
a sensor coupled to the cap, wherein the sensor is configured to detect rotational displacement of the magnet.

17. The suspension system of claim 16, wherein the rod includes an external thread, and wherein the second, elongate tubular body includes a piston engaged with the external thread.

18. The suspension system of claim 17, wherein a pitch of the external thread is such that any linear movement of the piston is configured to create a rotational displacement of the rod that is less than 360 degrees.

19. The suspension system of claim 16, wherein the sensor is a rotary sensor configured to detect a rotational displacement of the magnet.

20. A bicycle having a front fork, wherein the suspension system of claim 16 is disposed at least partially within the front fork.
